(19) United States
(12) Patent Application Publication
(10) Pub. No.: US 2008/0217468 A1
(43) Pub. Date: Sep. 11, 2008

(54) MAST FOR AN AIRCRAFT NACELLE INCORPORATING MEANS FOR LIMITING THE APPEARANCE OF VIBRATIONS, IN PARTICULAR IN CERTAIN FLIGHT REGIMES, AT A HIGH MACH NUMBER AND LOW LIFT

(75) Inventor: Thierry FOL, Grenade (FR)

Correspondence Address: YOUNG & THOMPSON, 209 Madison Street, Suite 500, ALEXANDRIA, VA, 22314, US

(73) Assignee: AIRBUS FRANCE, TOULOUSE (FR)

(21) Appl. No.: 12/043,157

(22) Filed: Mar. 6, 2008

(30) Foreign Application Priority Data
Mar. 8, 2007 (FR) 07/53716

(51) Int. Cl. B64D 27/00

(52) U.S. Cl. 244/54

(57) ABSTRACT

A mast for connection between a power plant and the rest of an aircraft that includes an outside surface (14) that is in contact with the air flows, characterized in that it includes, in the outside surface (14), at least one recess (22) that is blocked by a porous wall (24), with a porosity of 3 to 6%, coming into the extension of the outside surface (14), whereby the recess makes it possible to have the high-pressure zone (18) communicate with the low-pressure zone (20), zones that are arranged on both sides of a shock wave (16).

This invention relates to a mast for an aircraft nacelle that incorporates means for limiting the appearance of vibrations, in particular in certain flight regimes, at a high Mach number and low lift.

The power plant of an aircraft generally comprises an engine or turboreactor arranged in a nacelle, whereby said power plant is connected to the rest of the aircraft by means of a connection called a mast.

According to a widely used configuration, the power plant is mounted under the wing of the aircraft, but it can also be mounted on the wing, behind the fuselage or on the aircraft fuselage in the form of a flying wing.

The mast should ensure the transmission of mechanical stresses, in particular the thrust force, between the power plant and the rest of the aircraft, while adhering to the constraints of aerodynamic type, in particular to have minimal drag.

Consequently, the design of a mast and in particular its shapes is a multidisciplinary process, requiring numerous compromises for taking into account constraints that are often antagonistic.

For certain flight regimes, in particular for flights with a high Mach number and low lift, when the shock wave that appears in this regime is high enough, its interaction with the boundary layer of the mast entrains a separation from said boundary layer that can be the source of unacceptable vibrations for the aircraft, in particular if these vibrations excite poorly dampened structural modes. To attenuate the propagation of said vibrations, the shape of the skin of the mast is greatly limited by this phenomenon, which tends to further complicate the mast.

Also, this invention proposes a mast that incorporates means for limiting the appearance of vibrations, in particular in certain flight regimes, making it possible to reduce the constraints to which it is subjected.

For this purpose, the invention has as its object a mast for connection between a power plant and the rest of an aircraft that comprises an outside surface that is in contact with the air flows, characterized in that it comprises, at the external surface, at least one recess that is blocked by a porous wall, with a porosity of 3 to 6%, coming into the extension of said outside surface, whereby said recess makes it possible to have the high-pressure zone communicate with the low-pressure zone, zones that are arranged on both sides of a shock wave.

Other characteristics and advantages will emerge from the following description of the invention, a description that is provided only by way of example, with regard to the accompanying drawings, in which:

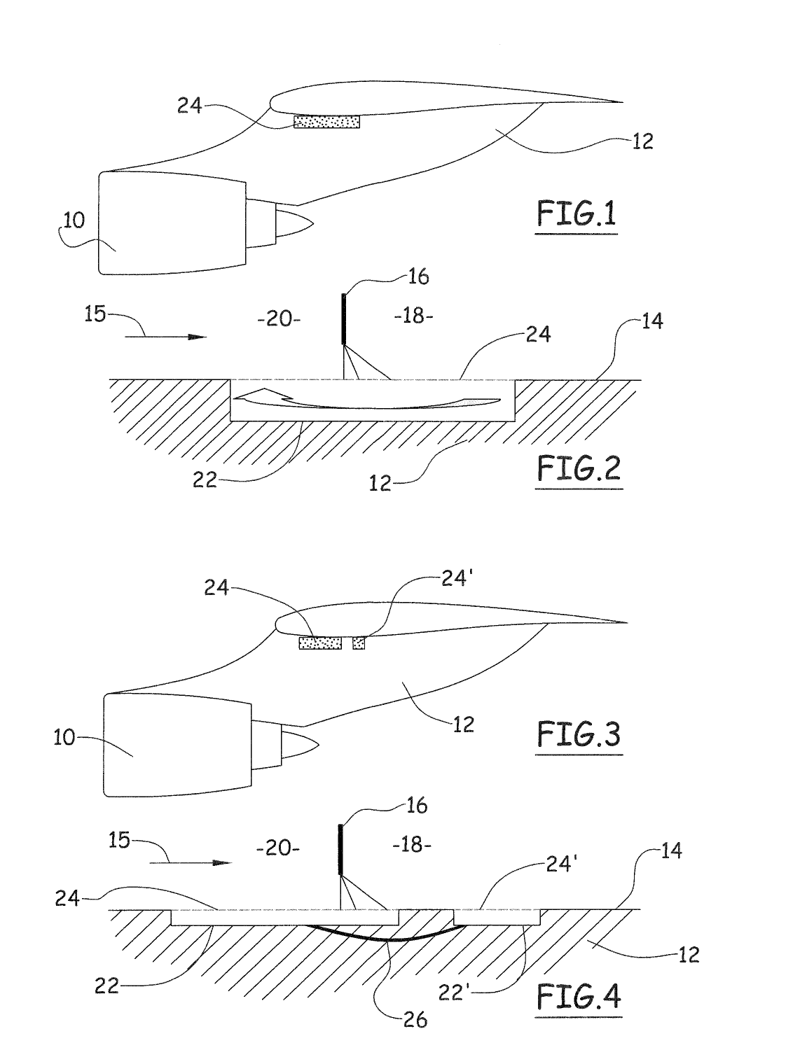

FIG. 1 is a lateral elevation view of a mast according to an embodiment,

FIG. 2 is a sectional drawing of a portion of the outside surface of the mast of FIG. 1,

FIG. 3 is a lateral elevation view of a mast according to another embodiment, and

FIG. 4 is a sectional drawing of a portion of the outside surface of the mast of FIG. 3.

In the various figures, a power plant of an aircraft was shown at 10. This power plant is generally incorporated into a passage that is also called a nacelle. This power plant generally comes in the form of a turboreactor. Nevertheless, the invention is not limited to this type of power plant but can be applied to all types of power plants.

This power plant 10 is connected to the rest of the aircraft by means of a connection, hereinafter called a mast 12. According to a widely used arrangement that is illustrated in FIGS. 1 and 3, the power plant is arranged under each of the wings of the aircraft. However, the invention is not limited to this arrangement but covers all the variants. Thus, the power plant can be mounted on the wings. It can also be connected to the fuselage, for example on the sides to the rear of the fuselage, or it can be mounted on the aircraft fuselage, which can assume the shape of a flying wing.

The mast 12 comprises an internal structure that makes it possible to ensure the transmission of mechanical stresses, arranged in a casing with an outside surface 14 that is in contact with the air flows.

The mast 2 has a section that makes it possible to reduce the drag. According to one embodiment, the mast 12 is essentially symmetrical along a vertical plane in the direction of air flow (indicated by the arrow 15), whereby said plane divides the outside surface 14 into a first side and a second side.

When the aircraft comes close to or exceeds the speed of sound, a shock wave 16 that delimits a high-pressure zone 18 to the front in the direction of the air flow 15 and a low-pressure zone 20 to the rear appears at the outside surface 14.

For certain flight regimes, in particular at a high Mach number and low lift, this shock wave 16 can generate strong vibrations.

According to the invention, to attenuate the intensity of the shock wave 16 and thus the vibrations, the mast 12 comprises, at the outside surface 14, at least one recess 22 that is made in the profile of the mast, whereby said recess is blocked by a porous wall 24 that comes into the extension of said outside surface 14. This porous wall makes it possible to ensure the continuity of the air flow at the surface of the mast without producing perturbations in said flow.

The recess 22 is made in at least one side of the mast, whereby its position is such that it makes it possible to have the high-pressure zone 18 communicate with the low-pressure zone 20 so as to reduce the pressure difference on both sides of the shock wave corresponding to the intensity of said shock wave.

The shapes and the dimensions of the recess, and the porosity of the porous wall 24 are such that the flow rate between the high-pressure zone 18 and the low-pressure zone 20 is satisfactory for reducing the intensity of the shock wave. According to the invention, the porous wall has a porosity of 3 to 6%.

According to a first variant that is illustrated in FIGS. 1 and 2, the recess 22 can extend over a sufficient length in the direction of the flow of the air 15 so that the shock wave is arranged to the right of said recess 22.

According to another variant that is illustrated in FIGS. 3 and 4, in at least one side, the mast comprises at least two recesses 22 and 22′, arranged one after the other in the direction of the flow of the air 15, each blocked by a porous wall, respectively 24, 24′, whereby at least one passage 26 makes it possible to have said recesses communicate. Thus, if the shock wave 16 is found to the right of a recess 22 or 22′ or between said recesses 22 and 22′, said recesses and the passage make it possible to have the high-pressure zone 18 and the low-pressure zone 20 communicate so as to reduce the intensity of the shock wave 16 and thus the vibrations. The number and the length of the recesses that are blocked by porous walls are such that the shock wave is between the upstream end of the first recess and the downstream end of the last recess in the direction of the flow of air 15.

The dimensions of the recesses, the number of recesses, the dimensions of the passages, and the porosity of the porous walls are adjusted so that the flow rate between the high-pressure zone 18 and the low-pressure zone 20 is satisfactory for reducing the intensity of the shock wave.

According to the embodiments, the recess or recesses are made in a single side or in two sides.

According to another advantage, the invention makes it possible to decouple the optimization of the external surface of the mast, whose purpose is to meet the aerodynamic objectives at cruising speed, from the management of risks of separation of the boundary layer. For greater effectiveness, the recess or recesses are arranged close to the junction of the mast with the rest of the aircraft, which is the site of maximum interaction between the shock wave and the very sensitive boundary layer that develops in this zone.

1. Mast for connection between a power plant and the rest of an aircraft that comprises an outside surface (14) that is in contact with air flows, characterized in that it comprises, in the outside surface (14), at least one recess (22) that is blocked by a porous wall (24), with a porosity of 3 to 6%, coming into the extension of said outside surface (14), whereby said recess makes it possible to have the high-pressure zone (18) communicate with the low-pressure zone (20), zones that are arranged on both sides of a shock wave (16).

2. Mast for connection between a power plant and the rest of an aircraft according to claim 1, wherein it comprises at least two recesses (22, 22′) that are arranged one after the other in the direction of the flow of air (15), each blocked by a porous wall (24, 24′), and at least one passage (26) that makes it possible to have said recesses (22, 22′) communicate.

3. Mast for connection between a power plant and the rest of an aircraft according to claim 1, whereby said mast is essentially symmetrical relative to a vertical plane that is arranged in the direction of the flow of air, whereby said plane divides the outside surface (14) into a first side and a second side, wherein it comprises at least one recess (22, 22′) in at least one side.

4. Mast for connection between a power plant and the rest of an aircraft according to claim 1, wherein said at least one recess (22) is arranged close to the junction of said mast with the rest of the aircraft.

5. Aircraft that comprises at least one mast according to claim 1.

6. Mast for connection between a power plant and the rest of an aircraft according to claim 2, whereby said mast is essentially symmetrical relative to a vertical plane that is arranged in the direction of the flow of air, whereby said plane divides the outside surface (14) into a first side and a second side, wherein it comprises at least one recess (22, 22′) in at least one side.

7. Mast for connection between a power plant and the rest of an aircraft according to claim 2, wherein said at least one recess (22) is arranged close to the junction of said mast with the rest of the aircraft.

8. Mast for connection between a power plant and the rest of an aircraft according to claim 3, wherein said at least one recess (22) is arranged close to the junction of said mast with the rest of the aircraft.

9. Mast for connection between a power plant and the rest of an aircraft according to claim 6, wherein said at least one recess (22) is arranged close to the junction of said mast with the rest of the aircraft.
